(19) United States
(12) Patent Application Publication
(10) Pub. No.: US 2002/0079605 A1
(43) Pub. Date: Jun. 27, 2002

(54) Method of manufacturing a plastics molded part with a soft-feel surface and a manufacturing tool to use in the method

(76) Inventors: Lee S. Pearson, Essex (GB); Michael Edson, Essex (GB); John Eves, Essex (GB)

Correspondence Address: Steven L. Oberholtzer, BRINKS HOFER GILSON & LIONE, P.O. Box 10395, Chicago, IL, 60610, US

(21) Appl. No.: 09/932,815

(22) Filed: Aug. 17, 2001

(30) Foreign Application Priority Data
Aug. 26, 2000 (GB) 0021009.6

(51) Int. Cl. B29C 45/14

(52) U.S. Cl. 264/46.4; 264/544; 425/542

(57) ABSTRACT

A plastics molded part with a soft-feel surface as a layer of soft material molded on the surface of the part. The edges of the soft material are protected and hidden by a rib which is part of the molded part, which extends in a plane which runs generally parallel to the contour of the part in the region of the rib and which is substantially coplanar with the surface of the part not covered by soft material. The soft material is placed in the mold prior to plastics injection. During injection, the soft material is compressed against the outer mold wall. On ejection from the mold, the soft material recovers and expands so that its outer surface is flush with the outer surface of the rib.

### TECHINICAL FIELD OF THE INVENTION

This invention relates to a method of and apparatus for molding a plastics article, at least a part of which has a “soft-feel” finish. This is based on Great Britain patent application Ser. No. 0021009.6, filed Aug. 26, 2000.

### BACKGROUND OF THE INVENTION

It is known to be desirable to incorporate a “soft-feel”, in other words a yieldable surface to parts, which have surfaces in the passenger compartment of a motor vehicle. This gives improved aesthetic/tactile comfort for the vehicle occupants and can help to minimize injury in the event of an impact of the vehicle with another object.

Most such parts, for example the instrument panel, the console and the door trims are molded in a shape, which has three dimensions. The manufacture of such parts calls for a molding, which is more often than not a plastics molding technique. The part needs to have sufficient “solid” plastics to support he shape and to support any loads, which will, in use, be imposed on the part.

The “soft-feel” is usually produced by applying a layer of soft material, typically foamed material, to the part surface. This layer of material can be attached to a molded part by adhesive after the part itself has been molded. This is time consuming, difficult to do and expensive.

It is also known to place the layer of soft material in the mold tool and then to use an injection molding process to mold plastic behind the material. However, with this technique it is difficult to make a tidy edge where the soft material meets the relatively rigid part.

### SUMMARY OF THE INVENTION

According to the present invention, there is provided a method of manufacturing a plastics molded part with a soft-feel surface, the method comprising the steps of preparing a sheet of soft material of a desired shape and form, preparing a mold tool to mold the part with a rib on the molded part extending generally parallel to the surface which will be covered by the soft material, placing the soft material in the mold tool with the edges of the material in register with the rib, injecting molten plastics into the mold tool to fill the tool and to compress the soft material, allowing the mold tool and its contents to cool and removing the molded part from the tool to allow the soft material to expand to fill the space behind the rib.

Soft material means any sheet-like material, which can be compressed in thickness and can subsequently recover to its original thickness. Rubbers and elastomers are examples of such material, but preferably the material is or includes a foamed plastic. More specifically, the material may be a laminate made up of an outer skin (which may be a continuous sheet material or a fabric, e.g., a woven or knitted cloth), a foam middle layer and an inner skin. After molding, the inner skin will bond to the injected plastics so that a unitary product is produced.

It is an advantage of the present invention that a molded part can be produced, with another surface, which, in part has a soft-feel and in part is hard, with the soft surface being substantially flush with the hard surface and there being substantially no gap where the soft-feel surface meets the hard surface.

The invention also provides a mold tool for manufacturing a part which has one surface portion having a soft-feel finish and another surface portion having a hard finish, wherein the tool half which will form the outer surface of the part has, in the region where the soft surface is to meet the hard surface, a cavity region extending substantially parallel to and outboard of the adjacent tool wall such that the molded part has a rib which extends along the region where the soft-feel surface meets the hard surface.

Other general and more specific aspects will be set forth in the ensuing description and claims.

### BRIEF DESCRIPTION OF THE DRAWINGS

The drawings that will now be briefly described are incorporated herein to illustrate preferred embodiment of the invention and a best mode presently contemplated for carrying out the invention.

FIG. 1 is a perspective view of a console armrest for a motor vehicle, constructed using the method of the present invention;

FIG. 2 to 4 show a cross-section through a set of mold tools, at a position corresponding to the position of the line A-A, at three sequential steps in the method; and

FIG. 5 shows a section on the line A-A through part of a completed armrest.

### DETAILED DESCRIPTION OF THE INVENTION

The following description of the preferred embodiment of the invention is not intended to limit the scope of the invention to this one embodiment, but rather to enable any person skilled in the art to make and use the invention.

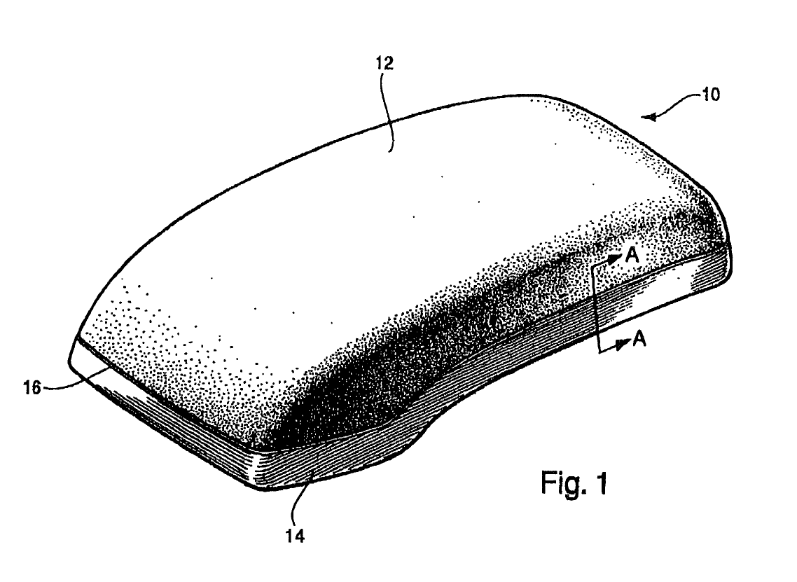

FIG. 1 shows a typical component 10 which can be manufactured using the process of this invention. The component is a motor vehicle armrest, which also forms a top cover to a storage box in a vehicle console between the vehicle front seats.

The armrest 10 has an injection molded plastic body which has a major surface 12 covered in a soft-feel material and edge region 14 where hard plastic is exposed. This invention is concerned with the region where the soft and hard surfaces meet, i.e., the detail at the junction line 16.

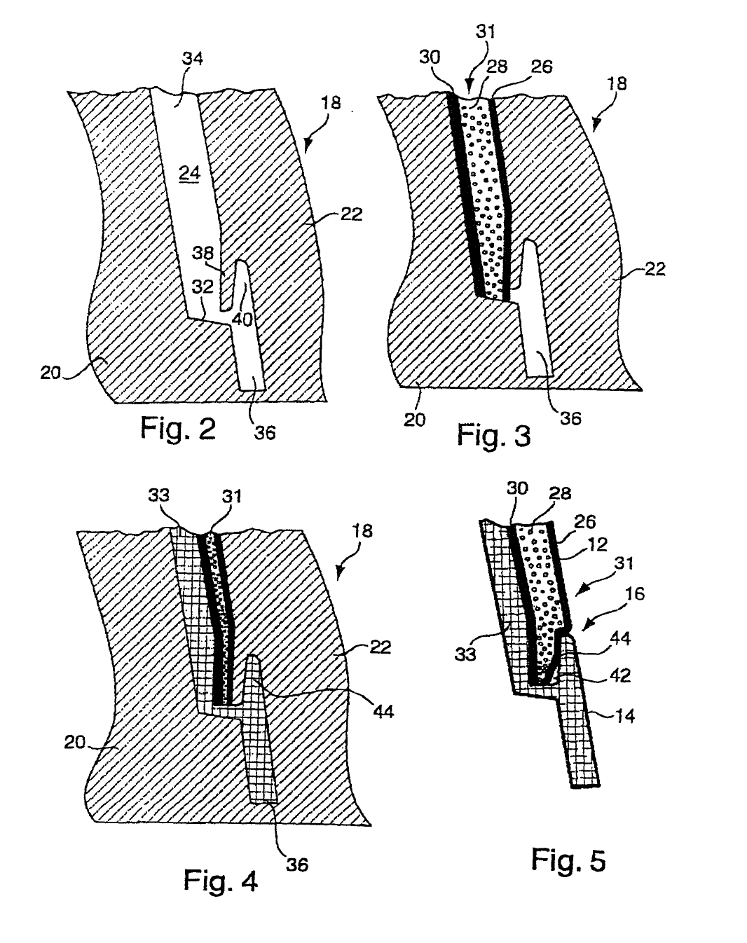

The armrest is to be manufactured by injection molding in a molding tool 18. FIG. 2 shows a section through a part of the tool, the section being taken on the lines A-A from FIG. 1. The tool has a core side 20 and a cavity side 22 which define a cavity 24 between them. The core side 20 and the cavity side 24 are shown in the relative positions they take up when the tool is closed.

The first stage in manufacturing this armrest is to prepare the material, which will form the soft-fee surface. In this example, the material is a three-layer laminate with an outer skin 26, a foam layer 28 and an inner skin 30. This can be seen in FIG. 3. A blank 31 of appropriate size is cut from a sheet, and is then vacuum formed into the approximate three-dimensional shape required to form the armrest surface.

The tool cavity 24 has an upper region 34 in which the upper part 12 of the armrest will be molded, and a lower region 36 in which the edge region 14 of the armrest will be molded. Between these two regions of the tool, there is a transition region. In the transition region, there is a step 32 on the core side of the tool. This step provides an edge against which the soft-feel material can be placed in the mold. On the cavity side of the tool, there is a downwardly-extending fin 38 and, outboard of that fin, a narrow recess 40. All of these features, i.e., the step, the fin and the recess extend all the way around the tool where the junction line 16 runs.

The next stage in manufacturing is to place the blank 31 in the tool, which at this stage will be open. As can be seen in FIG. 3, the edges of the blank fit against the step 32 in the mold cavity 24. At this stage, the foam is uncompressed and the soft-feel material blank 31 substantially fills the cavity 24.

Next, the tool is closed (FIG. 3) and molten plastic 33 is injected into the tool, using standard injection molding technology. Details of the injection equipment and of the tool features required to enable injection to take place are not shown, as they will be well known to the skilled man and form no part of this invention. The injection takes place from the core side 20 of the tool, and the pressure generated in the molten plastic by the injection equipment, as well as forcing the molten plastic by the injection equipment, as well as forcing the molten plastic inner layer 30 of the soft-feel blank 31 to compress the foam 28. This can be seen in FIG. 4. It will also be seen from FIG. 4 that once the foam has been compressed, a passage opens up between the upper and lower regions of the tool cavity at the step 32. The molding conditions, the composition of the inner laminate layer 30 and the injected plastics will be chosen so that a bond is formed during the injection process between the laminate and the injected plastic.

Suitable materials are: polypropylene for the base molding, extruded polypropylene for the inner layer 30, polypropylene foam for the core 28 and TOP (thermoplastic olefins) for the outer layer 26. The outer layer can if desired be printed with a grain pattern, carry a flocked surface or have some other decorative finish. Many other different materials and combinations of materials can however be used, and the invention is not restricted to any particular material or materials. Alternatively, the outer skin 26 can be a fabric, for example a woven or knitted fabric.

Once injection has been completed, and the plastic has set, the tool is opened. Once the constraint provided by the cavity tool wall is removed, the foam expands again (this time expanding from the inner laminate layer 30 outwards) so that the soft-feel characteristic is restored and so that the outer layer 26 of the laminate lies flush with the outer surface of the hard plastic edge region 14. The edges of the blank 31 are hidden in a channel 42 formed in the molded part by the fin 38, and are thus concealed.

The dimensions of the blank and of the tools are designed so that, when the form in the blanks expands after removal from the mold tool, the outer surfaces 12 and 14 are substantially flush with one another. This provides a neat finish to the part, and no major finishing operations are required after the part has been removed from the mold.

It is believed that a method of an apparatus for molding a plastics article, at least a part of which has a “soft-feel” embodying principles that have been described and illustrated herein to improve the method and part performance and durability.

The foregoing discussion discloses and describes preferred embodiments of the invention. One skilled in the art will readily recognize from such discussion and from accompanying drawings and claims that change and modifications can be made to the invention without departing from the truth and fair scope of the invention as defined in the following claims. The invention has been described in an illustrative manner and it is to be understood that the terminology, which has been used, is intended to be in the nature of the words of description rather than of limitation.

1. A method of manufacturing a plastics molded part with a soft-feel surface, the method comprising the steps of preparing a sheet of soft material of a desired shape and form, preparing a mold tool to mold the part in such a way that a rib on the molded part extends generally parallel to the surface which will be covered by the foamed material, placing the soft material in the mold rib, injecting molten plastics into the mold tool to fill the tool and to compress the soft material, allowing the mold tool and its contents to cool and removing the molded part from the tool to allow the soft material to expand.

2. A method as claimed in claim 1, wherein the soft material includes a foam material.

3. A method as claimed in claim 1, wherein the soft material is a laminate with a layer of foam between two flexible webs.

4. A method as claimed in claim 1, wherein the sheet of soft material is vacuum formed before being placed in the mold tool.

5. A mold tool for manufacturing a part which has one surface portion having a soft-feel surface and another surface portion having a hard surface, wherein the tool half which will form the outer surface of the part has, in the region where the soft-feel surface is to meet the hard surface, a cavity region extending substantially parallel to and outboard of the adjacent tool wall such that a molded part formed in the tool will have a rib which extends along the region where the soft-feel surface meets the hard surface, and extends in a plane which runs generally parallel to the adjacent surface of the molded part.

6. A mold tool as claimed in claim 5, wherein the rib of a molded part formed in the tool will be substantially coplanar with the hard surface.

7. A plastics molded part with a soft-feel surface, the soft surface ending in a recess extending around and close to the edge of the molded part.
